(19) United States
(12) Patent Application Publication
(10) Pub. No.: US 2012/0296747 A1
(43) Pub. Date: Nov. 22, 2012

(54) METHOD, SYSTEM, APPARATUS, AND PROGRAM FOR DISPLAYING TARGETED ADVERTISEMENTS

(76) Inventor: C. Richard Triola, Laguna Beach, CA (US)

(21) Appl. No.: 13/452,706

(22) Filed: Apr. 20, 2012

Related U.S. Application Data
(63) Continuation-in-part of application No. 11/437,985, filed on May 18, 2006, now Pat. No. 8,204,807.
Application No. 11/437,985 is a continuation of application No. 09/833,390, filed on Apr. 11, 2001, now Pat. No. 7,127,406.
(60) Provisional application No. 60/198,785, filed on Apr. 20, 2000.
(60) Provisional application No. 61/477,386, filed on Apr. 20, 2011.

(51) Int. Cl. G06Q 30/02

(52) U.S. Cl. 705/14.66

(57) ABSTRACT

A method, system, apparatus, and program for advertising in a web portal, such as an electronic document processing web portal, and displaying advertisements to users that are particularly tailored to the user.

### BACKGROUND OF THE INVENTION

1. Field of the Invention

The present invention generally relates to advertising in a web portal on a medium such as the Internet, and more particularly to a method, system, apparatus, and program for advertising in a web portal, such as an electronic document processing web portal, and displaying advertisements to users that are particularly tailored to the user.

2. Description of the Related Art

As the Internet becomes more and more expansive, new online communities and audiences are continuously being created which interact in dedicated web portals and the like. Such communities may interact for a variety of reasons, including entertainment, business, etc.

Many such online communities have a unique set of like-minded participants. The Applicant has discovered that there is a need to reach these participants with effective advertising that is particularly tailored to the participants and to their reason(s) for being in such web portal. Thus, there is a need for advertising methods that specifically target such participants, based on information unique to the participants.

### SUMMARY OF THE INVENTION

The Applicant has discovered a new opportunity and a new way to serve and/or provide benefits, such as advertising benefits, to an online community of like-minded parties. The emergence of e-commerce has generated a need for a computerized method, system and apparatus for serving tailored advertisements to specific parties participating in an online community.

Needs such as the foregoing are met by a system, apparatus, and computer program that operate in accordance with the method for displaying targeted advertisements to participants in an online community or web portal, such as a web portal that enables the electronic processing of documents and transactions.

According to an example aspect of the invention, an online community is in the form of a web portal that provides access to a so-called “e-signing room” where users can electronically sign documents in the furtherance of a transaction such as, e.g., a real estate transaction. A directed advertising program in accordance with the invention offers benefits to specific targeted parties to that transaction, e.g., Submitters, Recipients, principals, brokers, agents, service providers, vendors, affiliates, third parties, etc. The parties can be served ads on the basis of, e.g., their profession, their work, their location, the applications or tools they use in the course of their work, etc. For example, in a real estate and mortgage transaction there are several parties that would be processing electronic documentation through an electronic platform that would include signatures, authentication, instructions, disclosures, background searches, identity credentials/authentication, agreement, contracts, registering, recording, notarization, purchasing, selling, managing, reporting, communications, validation, submissions, referrals, etc.

The e-signing room connects parties and documents within a secure electronic environment. Such a system may grant users permission-based access. According to an aspect of the invention, when a party or person enters either the signing room, or prepares documentation/instructions, or submits, or receives, or opens document(s) for review, acceptance, signing, etc., each party receives a specific targeted message, advertisement, banner, etc., that can be retrieved electronically. The party can then, for example, print the offer. Targeted marketing messaging is implemented/generated based on a number of factors including, but not limited to, unique or custom signing room or documents, a unique database that is authenticated by electronic, digital, signing pad, retinal scan, voice or video recognition, personal records, and the like.

Parties may pre-register into the system and, based on certain credentials, a marketing message can also be generated. For example, when a certified notary enters the system and completes registration, the system automatically tags this person, accorded with specific rights and privileges, and once the notary enters the secure platform, signing room, vpn, and the like and is authenticated, a direct and unique marketing message is presented. For example, assume the transaction is a real estate transaction. An agent gains access to a secure signing room in order to submit contracts/agreements to buyers, sellers, service providers, etc., for review and signature. Once the agent is “in the room,” he or she is presented with marketing messages/offers, etc., such as from mortgage companies, title or closing agents, auto dealers, local businesses, regional and/or national chains, etc. (i.e., targeted based on profession, location, etc.) Once the recipient or Buyer receives the document(s) and enters the room and/or views the document(s), they may receive targeted messaging unique to them such as local retail offers, pizza, dry cleaners, etc., home improvement services, or mortgage companies. A seller, for example, may receive offers from trucking companies, or vacation offers, etc.

In another example aspect of the invention, a system grants access to public/private records (such as court documents accessible by, e.g., attorneys or parties or others) through a secure private network with certain user credentials, rights, and privileges. Once a party or user enters this service, the party is presented with advertising/promotional messages directed to that specific or unique user.

In another example aspect of the invention, a party may access a system through a secure gateway that allows for a search of records, and, based on the data that party enters, a unique marketing message is sent and available to that party. For example, assume a potential buyer wishes to know the price other houses in the area are selling for. Once the party is authenticated and enters its own address, a marketing message may be offered based on that data—data such as street address, zip code, phone number, etc. The party can then receive a targeted message from, e.g., a local real estate agent, a moving company, a landscaping company, etc.—any service that a potential party would be interested in.

According to an aspect of the invention, a portal serves as an intermediary to allow on-demand submitting parties (including clients or non-clients) to submit documents to Recipient(s) for the purpose of legally accepting, authenticating, and executing/closing documents/transactions by affixing a legally binding electronic signature to any/all correspondence/documentation. An agreement, document, or any type, is delivered through the portal to be delivered directly by the Submitter to the Recipient (referred to as ‘Principals’) only upon the fulfillment of all the conditions precedent which are imposed upon the principals, and are usually of the express terms and conditions of a purchase and sale agreement (also referred to more simply as a “sales contract” hereinafter), not limited in scope. In accordance with an aspect of the invention, advertisements are served to the portal for display to the users therein, said advertisements being particularly tailored to the user. The ads can be tailored on the basis of location, type of transaction, type of party the user is (buyer, seller, attorney, agent, etc.), etc.

The present invention according to an aspect provides targeted advertising to specific users participating in on-line digital transactions via an on demand portal upload, via a medium such as the internet. Multiple access methods are employed. The present invention provides computerization and internet type process implementation. The present invention serves specifically tailored advertisements to users who have gained access to a secure transmission, network, vpn, or “signing room.”

Party and third party personal identification authentication can be performed, such as on-line digital signature, thumb-print, retinal scan, biometrics, video signature authentication, digital certificate authentication, and the like, generically referred to hereinafter as identification authentication.

For verification of credentials, the present invention in one aspect authenticates users and validates the credentials of the user through private key encryption, which is a process that identifies valid transactions by verifying the encrypted key (digital certificate) used to sign a document. This signature key is validated with private keys held by the document recipient and master keys held by trusted third parties. Invalid keys (signatures) are instantly identified, thereby providing a level of fraud protection not available with legacy manual systems.

The present invention in one aspect provides for a web browser (or the like) for opening, processing, and closing of a transaction, such as a transaction for real or personal property.

The present invention in one aspect provides a method and apparatus for tailoring and serving advertisements to particular users or classes of users during computerized digital transactions using multiple access such as Internet, intranet, and extranet, via all connectivity types which include but are not limited to wireless, satellite, dial-up, or leased communications.

The present invention in an aspect provides a system for real-time or near-real-time serving of specifically tailored advertisements during execution of computerized transactions.

In a basic aspect according to an example embodiment, the present invention provides an apparatus for personal and business-to-business transactions, including: a computer based automation system, having components providing implementation, management, and tracking of transactions, wherein data for implementing, managing, and tracking the transactions is accessible for specific parties to said transactions.

Accordingly, according to an aspect of the invention, a user upon entering a secure room of the web portal, such as a “signing” or “e-signing” room, may be served ads tailored to the particular user or the user's authentication information (location, job, profession, etc.). Ads can be served based on the user's identifying information (e.g., zip code, town, street address), the user's profession, the fact that the user is in the room, etc.

A system of an embodiment of the present invention creates ads or banner ads or has a database of potential ads and serves them (e.g., uploads them to the signing room) based on the targeted customer/user. The present invention can target ads for specific portals. For example, in one embodiment the present invention operates in the environment of a web-based system that grants attorneys access to court records on demand in real time. Advertisers who would like to reach attorneys in general would be interested in posting ads, and the present invention can effect that. Portal ads can be specifically placed for attorneys in particular areas such as Raleigh, N.C., etc. The present invention can also operate in the environment of Signing Rooms unique to particular companies. Ads can then be targeted to the users as a whole and/or by area, zip code, etc. For example, say Real Estate Company X has agents nationwide. The present invention can accommodate (and serve ads to users from) a National Mortgage company or a title company wanting to reach that audience or may have a Local Mortgage or Title company that only wants to reach agents in Orange County, Calif. or Palm Beach, Fla., or 11757 zip codes. In the same signing room agents are sending contracts/agreements to buyers, sellers, and borrowers. Each would be a valuable target for certain advertisers.

Thus, ads can be served inside a signing room from specific advertisers interested in targeting specific customers or users. There can be a “master” signing room serving ads to general users (such as ads from tire companies or cars), and an “individual” signing room serving more tailored ads to more specific users (such as a portal for attorneys in North Carolina, with the ads being North Carolina golf courses, etc.).

Thus, the present invention according to an embodiment gathers information about the parties entering the signing room, takes that information about a party who has entered the signing room, and determines which ads to display to said party.

According to an embodiment of the present invention, an advertising message, offer, etc., can be offered to a specific group as a whole or to any one person in the signing room or vpn. For example, if a buyer is in the process of purchasing a new home and is electronically processing purchase agreements, contracts, amendments, etc., a system of the present invention can drill down to the specific are code and automatically generate “Welcome to the Neighborhood” type messages, offers, etc., from local merchants in that particular zip code. The present invention according to an aspect provides a system for selecting and displaying targeted advertisements in a web portal enabling electronic processing of documents. The system includes a server coupled to a network including a memory and a processor configured to: (1) via online communications provide an e-signing room in the web portal that enables at least one of viewing, uploading, and downloading of documents, and electronic or digital signing of said documents; (2) provide access to the e-signing room to at least one party based on a registration or receiving or authentication process (e.g., a party receives an e-mail and the present invention can capture the recipient's info prior to sending), (3) determine at least one characteristic relating to the at least one party from the registration or authentication process, (4) access a memory of advertisements having key words relating to each advertisement, (5) search the database for at least one advertisement that is particularly suited to the at least one party based on a comparison of at least one characteristic to the key words relating to the advertisement, (6) select at least one advertisement from the memory based on the search, and (7) serve the at least one advertisement selected from the memory to the e-signing room.

The apparatus and method according to another aspect also implements, manages, and tracks on-line digital transactions via an escrow, including opening, servicing, real-time or near-real time status of the broker, title company, lender, vendor, buyer and seller, and closing of an escrow via a medium such as the internet. Multiple access methods are employed. The present invention provides computerization and internet type process implementation for escrow processes including, but not limited to, digital transaction coordination, digital status coordinators, seamless escrow transactions, on-line digital signatures, video signature authentication, digital certificate authentication, signature authentication, satellite and other wireless transmission of escrow transactions, voice digital instruction, the merging of voice with digital data transactions, set-top/WebTV digital escrow transmission, global digital escrow networking, and the like. The system includes appropriate data, application, and servers along with supporting LAN or WAN-based application to perform escrow services.

The present invention provides a method and apparatus for independent third party transaction facilitation, providing on-line digital escrow services.

The present invention provides a software system for offering secure escrow accounts for the acquisition of real and personal property and for business-to-business transactions using such vehicles as the internet, world wide web, wireless telecommunications and the like.

The present invention provides a method and apparatus for digital escrow transactions.

The present invention provides an internet (or the like) based automation system that provides for implementing, managing, and tracking escrow transactions which will be accessible for specific parties to a particular transaction.

The present invention includes security measures for digital escrow transactions.

The present invention provides for a web browser (or the like) for opening of escrow for both real and personal property via on-line entry of escrow instructions, and further including remote printing of escrow documents for party signatures or some other method of electronic signature, ordering all of escrow related services to appropriate service providers, accepting status updates for service providers and/or seller and/or buyer, viewing item status and activity associated with each escrow performance item, tracking of all fund transfers through all processes, and final closing of escrow.

The present invention provides a method and apparatus for safe and secure harbor of escrowing real and personal property and business-to-business transactions over vehicles such as the internet and wireless communications.

The present invention provides a method and apparatus for computerized digital escrow transactions including broker status, lender status, buyer & seller status, and the transaction servers coupled using multiple access such as internet, intranet, extranet, via all connectivity types which include but are not limited to wireless, satellite, dial-up, or leased communications.

The present invention provides a system for real-time or near-real-time escrow transactions including appropriate data, application, and web servers along with supporting network based applications to perform at least one of the following for authorized parties to an escrow:

receive/store escrow instructions upon submission by a party to the escrow (or their agent) via a computerized communications device;

disseminating instructions to all relevant parties by electronic means, fax, or physical delivery, including preference determination;

providing escrow documentation electronically;

providing escrow documentation approval;

automating order specified services through electronic means;

real-time and near-real-time display of escrow instructions, status, and activity;

providing for electronic personal identification authentication; and

closing escrow;

release of escrow funds;

digital transfer of escrow funds.

In a basic aspect, the present invention provides an apparatus for escrow transactions, including: a computer based automation system, having components providing implementation, management, and tracking of escrow transactions, wherein data for implementing, managing, and tracking the escrow transactions is accessible for specific parties to said escrow transactions.

In another aspect, the present invention provides a client-server computer system for escrow of property, including: at least one client module associated with at least one client party for initiating an escrow process with at least one escrow party; and as at least one server module associate with the escrow party, wherein a specific escrow account between said client party and said escrow party is established, maintained, tracked, and consummated via said client-server computer system.

In still another aspect, the present invention provides a computerized method for escrow such as the escrowing of property and business-to-business transactions, the method including: providing a computer based automation system of components, including components providing implementation, management, and tracking of the escrow wherein data for implementing, managing, and tracking the escrow transactions is accessible for specific parties to said escrow.

In yet another aspect, the present invention provides a process for a computerized escrow transaction including: providing escrow account, escrow status, broker status, lender status, buyer status, seller status, and vendor status via a centralized server associated with an escrow officer, and connecting parties to said computerized escrow transaction using multiple computer network access devices via connectivity types which include but are not limited to wireless, satellite, dial-up, or leased communications.

In another aspect, the present invention provides a system for real-time or near-real-time escrow transactions, including: appropriate data, application, and transactional management programs; and supporting network based applications to perform at least one of the escrow services selected from a group including: receiving and storing escrow instructions upon submission by a party to the escrow transaction via a computerized communications device; disseminating instructions to all relevant parties by computer; providing escrow documentation; providing escrow documentation approvals; automating order specified services; real-time and near-real-time display of escrow instructions, status, and activity; on-line digital identification authentication; transfer of ownership; closing escrow; releasing of escrow funds; and digital transfer of escrow funds.

In a further aspect, the present invention provides a method of doing business using an internet including: providing an on-line escrow account for parties to a transaction; providing on-line transactional account management services with respect to the on-line escrow account for said parties; and providing secure access to said on-line escrow account limited to the parties and third parties using on-line identification authentication.

In another aspect, the present invention provides a computer memory including: program code providing a client-server based automation system for an escrow transaction; program code providing implementation, management, tracking, and closing of specific escrow transactions; and program code allowing escrow transaction data access only for specific parties to said escrow transaction.

The foregoing summary is not intended to be an inclusive list of all the aspects, objects, advantages, and features of the present invention nor should any limitation on the scope of the invention be implied therefrom. This Summary is provided in accordance with the mandate of 37 C.F.R. 1.73 and M.P.E.P. 608.01(d) merely to apprise the public, and more especially those interested in the particular art to which the invention relates, of the nature of the invention in order to be of assistance in aiding ready understanding of the patent in future searches. Objectives, features and advantages of the present invention will become apparent upon consideration of the following explanation and the accompanying drawings, in which like reference designations represent like features throughout the drawings.

### BRIEF DESCRIPTION OF THE DRAWINGS

The features and advantages of the present invention will be more readily understood from a detailed description of the exemplary embodiments taken in conjunction with the following figures:

FIG. 1 is an illustration of an embodiment of the present invention. FIG. 1 extends across three sheets marked FIG. 1A, FIG. 1B, and FIG. 1C, to be understood to comprise FIG. 1 in references thereto hereinafter.

FIG. 2 is an exemplary computer screen display illustrating an exemplary, computerized

Log In screen in accordance with the present invention as shown in FIG. 1.

FIG. 3 is an exemplary computer screen display illustrating an exemplary, computerized Escrow Form in accordance with the present invention as shown in FIG. 1.

FIG. 4 is an exemplary computer screen display illustrating an exemplary, computerized escrow status internet page in accordance with the present invention as shown in FIG. 1.

FIG. 5 shows an example aspect of the present invention using the Internet, wherein the invention is implemented on an on-demand portal.

FIG. 6 shows a method of operation of the present invention according to an example aspect.

FIGS. 7-12 are screen shots showing example aspects of the present invention.

FIG. 13, which is comprised of FIGS. 13A and 13B, shows a method of operation of the present invention according to an example aspect, in particular using a portal such as the portal shown in FIG. 5.

The drawings referred to in this specification should be understood as not being drawn to scale except if specifically annotated.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

The present invention relates generally to advertising methods in a web portal on a medium such as the Internet, and more particularly to a method, system, apparatus, and program for advertising in a web portal, such as an electronic document processing web portal, and displaying advertisements to users that are particularly tailored to the user.

More particularly, an aspect of the present invention provides a method, system, apparatus, and program which provides:
electronic transmission of advertisement messaging sent or received via a system that enables all parties to receive, transmit, send, view, sign (electronic sign, digitally sign, biometrically sign, signing pad sign, wet sign, print sign and fax), scanned documents or images and the like, or sign or process, authenticate, validate, etc., documents that are to be reviewed, executed, and authenticated;
targeting of customers based on their unique attributes, including individual, specific, or unique or branded or enterprise or vertical, electronic or digital signing room or portal or access to perform electronic processing of documents, information, material, etc., i.e. Settleware Branded Signing Room and those users granted access based on certain criteria, rules, permissions, or Keller Williams Signing Room (users are pre-approved), or Attorney access to a secure room or private network with proper credentials, or specific verticals such as, HR, Import/Export, Sales, Trucking, Insurance, Legal, Real Estate, Escrow, Lenders, Closing Agents, Entertainment, Government, Education, and the like;
relationship networking marketing (unique site visitors sharing specials, promotions, coupons, banners, advertising, etc., with friends/parties outside of the secure, private network;
Ad transfer from one medium to another. For example, a bar-coded digital ad presented in a secure network or signing room or presented over the Internet can be transmitted to another device such as a smart phone, tablet computing and the like. The customer can then present that uploaded digital ad, coupon, promotion, etc., to the retailer or advertiser (a first option is via a secure virtual private network, a second is through an e-signing room or process and a third is as a stand-alone process over the Internet). This is a unique and novel service over the Internet. Other options are available also.
A party can print offers/ads which may be embedded with a unique identifier, or be offered a promotion, generated through the secure network, vpn, or e-sign room or process, via direct marketing (in paper format), take a picture of the ad/coupon via their smart phone, and then present it to the retailer or advertiser. Advertising can be presented in a number of ways, including but not limited to, in paper, via mobile devices, via an electronic communication from a consumer device to a retail device, etc.
Keywords: secure network, transmission, access, delivery, authentication, identity verification, notarization, electronic or digital eSign portal, embedded advertising, mobile, private, traffic generation, interactive, targeted, measured, analytics, data mining, embedded link advertising, embedded link exchange (with ads or documents or both), transit, analytics, permission-based access, roles, privileges, display ads, custom targeting, pre-defined targeting, data attributes, third party providers connecting directly to customers, data management, data enrichment, manage customer identity or information or databases, promotions, banners, fundraising, critical data marketing to optimize advertising, relationship marketing, demographic data, relationship networking marketing (unique site visitors sharing specials, promotion, coupons, banners, advertising, etc. with friends/parties outside of secure, private network), affiliated relationships, marketing, multi language messaging or ads, video or audio messaging or transmission, video or audio advertisement, viral marketing campaign, referral-based marketing.

Reference is now made in more detail to specific embodiment(s) of the present invention which illustrate preferred embodiment(s) of the invention. Alternative embodiment(s) are also described as applicable.

With the method for authenticated permission-based advertising according to an aspect of the present invention, parties that enter a private “Signing room” to prepare, submit, process, etc., documents/transactions are presented documents, messaging, requests, instructions, etc., to be electronically processed, delivered, signed, transmitted, etc. would be granted rights to view/access special embedded advertising, including but not limited to promotion, coupons, special offers, discounted services, etc.

Further, recipient of electronically processed documents are granted access to advertising promotions, coupons, special offers and the like through a secure virtual private network and/or other systems whereby recipients are granted permission based access and/or certain user rights and privileges.

Moreover, Submitters, Recipients, and/or all parties would have ability to process through mobile, internet, etc. Parties to receive advertising promotions, coupons, special offers and the like through a secure virtual private network and/or other systems whereby recipients are granted permission based access and/or certain user rights and privileges.

Further, the invention includes Embedded advertising documents.

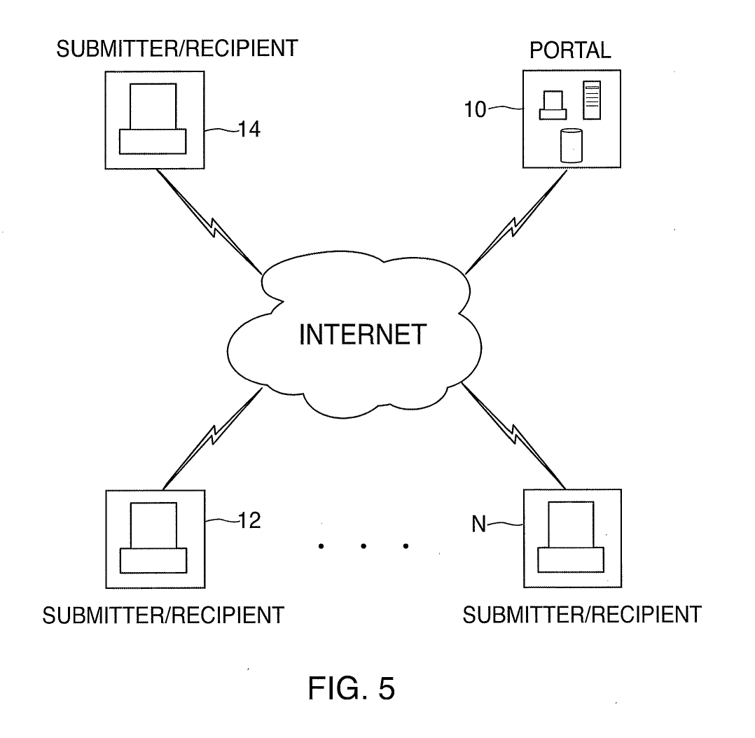

FIG. 5 shows an example aspect of the invention using the Internet, wherein the invention is implemented on an on-demand website or portal 10 including a server or web server that hosts the website. The on-demand portal 10 can communicate through the Internet with a number of end users having terminals 12, 14, . . . N, who may act as Submitters and/or Recipients. The portal 10 can run and support network-based applications including software routines and computer modules to perform at least some of the functions of the present invention. (For the sake of simplicity, Internet Service Providers, routers, firewalls, and the like that are well known in the art are not shown.)

The Submitters/Recipients can access the portal through their own personal computing system or terminal, which may be a lap top, a desk top, a mobile device, tablet pc, etc., including, for example, a keyboard, a mouse, a touch screen, a trackball, and/or any other suitable type of user-operable input device(s). The output user interface may include, for example, a video display, a liquid crystal or other flat panel display, a speaker, and/or any other suitable type of output device for enabling a user to perceive outputted information. Such mobile device could include beepers/pagers, such as Blackberry pagers, that have visual and interactive capabilities, along with a means of downloading or uploading content (for example, over the air or attached to a computer); another example is a PDA (Personal Digital Assistant) such as an iPhone, Android, PalmPilot, SmartPhone, Tablet PC, or PocketPC.

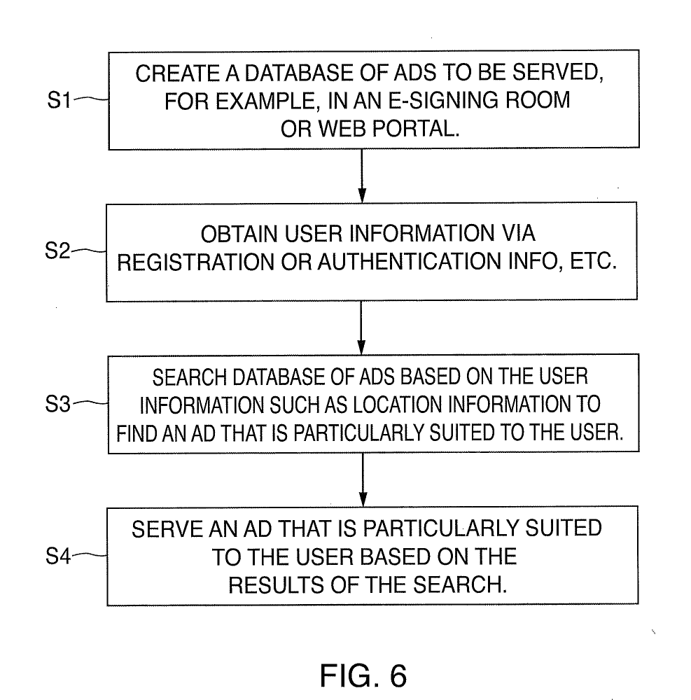

According to an aspect of the invention as shown in FIG. 6, the method, apparatus, system, or computer program in step Si creates, imports, accesses, or maintains a database or memory of ads to be served in an e-signing room or web portal. These ads can be created or imported into the database. In step S2 user information is obtained via registration or authentication info, etc. The user information can be information such as profession, title, job, occupation, hobby, interest, profile, location, street, city, state, zip code, area code, location of job, location of home, residence, age, sex, etc. In step S3 the database of ads is searched based on the user information (such as location information or based on the markets that a particular advertisement space the user is viewing represents) to find an ad that is particularly suited to the user. This can be done in various ways. One way, for example, is by comparing key words or tag words relating to the ad (e.g., “real estate”) to key words in the user information (e.g., title: “real estate agent”). Another way, for example, is by first categorizing the ad (e.g., by zip code, city, state, subject matter (cars or tires), etc.) and then comparing the relevant category (e.g., city) to the city listed in the user information. Users can be profiled and assigned to particular markets by analyzing their IP addresses and web browser information. Certain markets can be given more weight than others in the decision of which ads to select or where to display them. In step S4 a specific ad that is particularly suited to the user is served in the e-signing room based on the results of the search. The served ad can be, for example, an ad in which words in the user information match certain keywords or tag words in the ad, or a category of the ad matches a relevant category in the user information, etc. In this way, relevancy of the ad can be determined based on criteria in the user information (title, occupation, location, etc.). An ad server can serve the ads to the users, and is connected to either the Internet or to a web portal of the system. The ads can be text, graphics, still images, video images, a combination of these, etc., and can include embedded hypertext links or pop-up windows and the like.

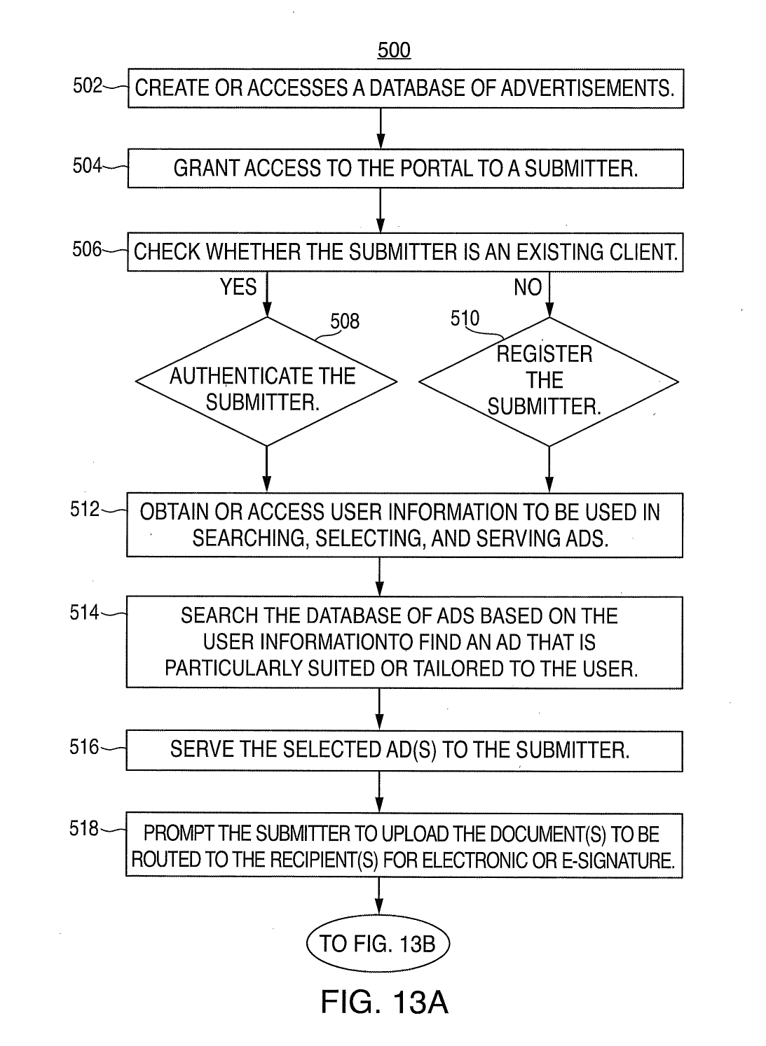

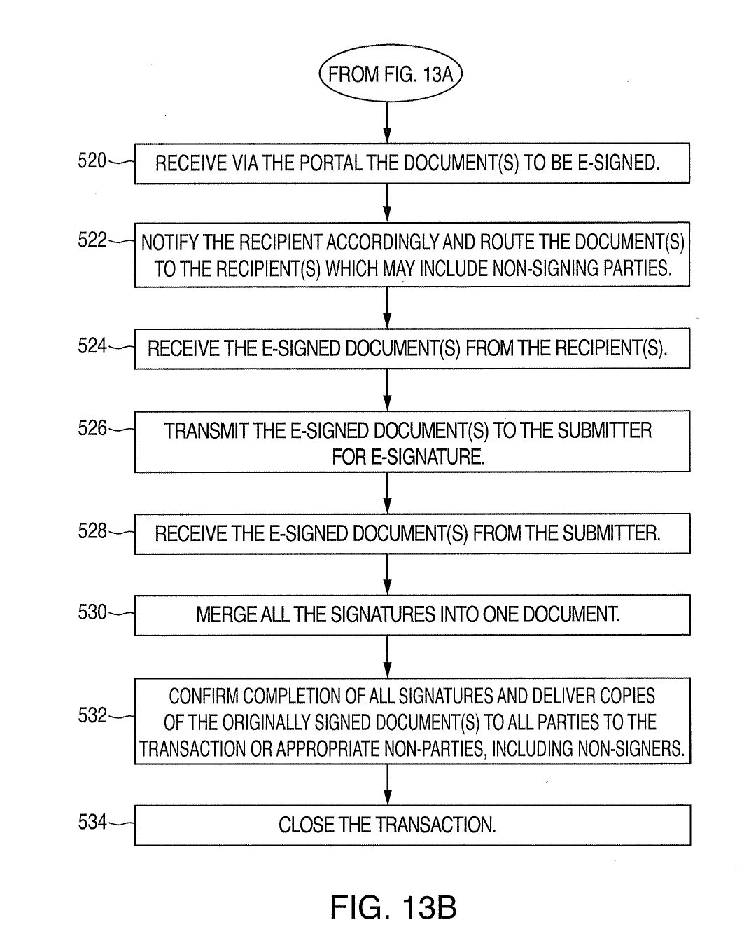

FIG. 13 shows a method 500 of operation of the present invention according to an example aspect, in particular using the portal 10 shown in FIG. 5. It is of course to be understood that this is only an example (and is not meant to be all encompassing) of steps that may be included in the method. Thus, while FIG. 13 focuses on Submitters and Recipients, ads can of course be served to other parties/users as well, as discussed above.

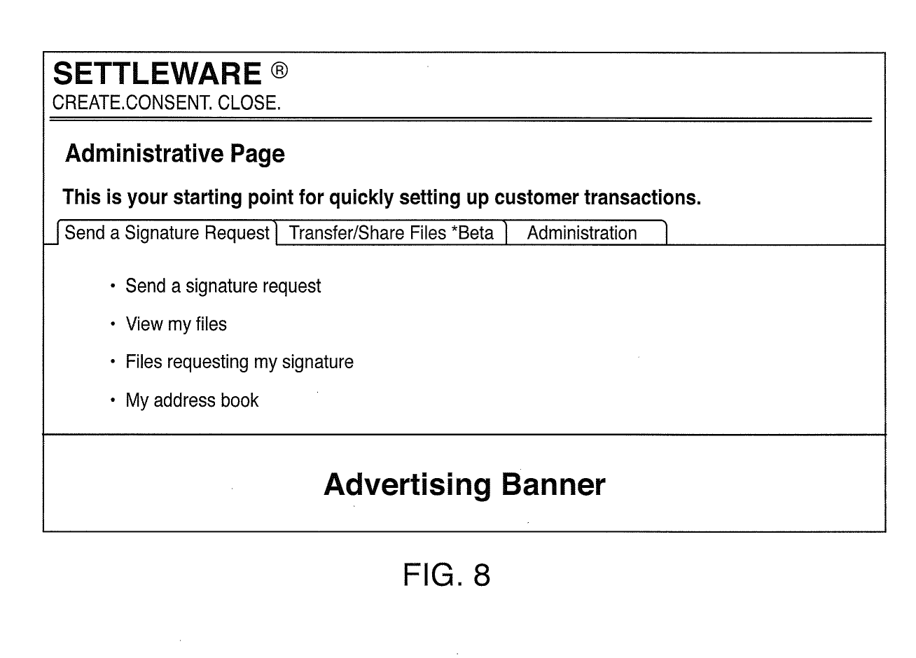

In step 502, the method creates, imports, maintains, or accesses a database or memory of advertisements to be potentially served to parties in the portal 10. In step 504, a Submitter 12 of a document to be e-signed accesses the portal 10 to enter the system. One example is shown in FIG. 8. In step 506 the portal 10 checks whether the Submitter 12 is an existing client. If so, in step 508, the portal 10 proceeds to authenticate the Submitter 12. If not, in step 510, the portal 10 proceeds to register the Submitter 12. In any event, in step 512, the portal 10 obtains or accesses characteristic information or user information based, for example, on the Submitter's authentication or registration, to be used in searching, selecting, and serving ads to the Submitter (or user or Recipient). The user information can be information such as profession, title, job, occupation, location, street, city, state, zip code, area code, location of job, location of home, residence, age, sex, etc.

The authentication of the Submitter 12 can occur in a number of ways, including but not limited to on-line digital signature, thumb-print, voice, video fingerprint, retinal scan, video signature authentication, video recording of transactions, digital certificate authentication, etc.

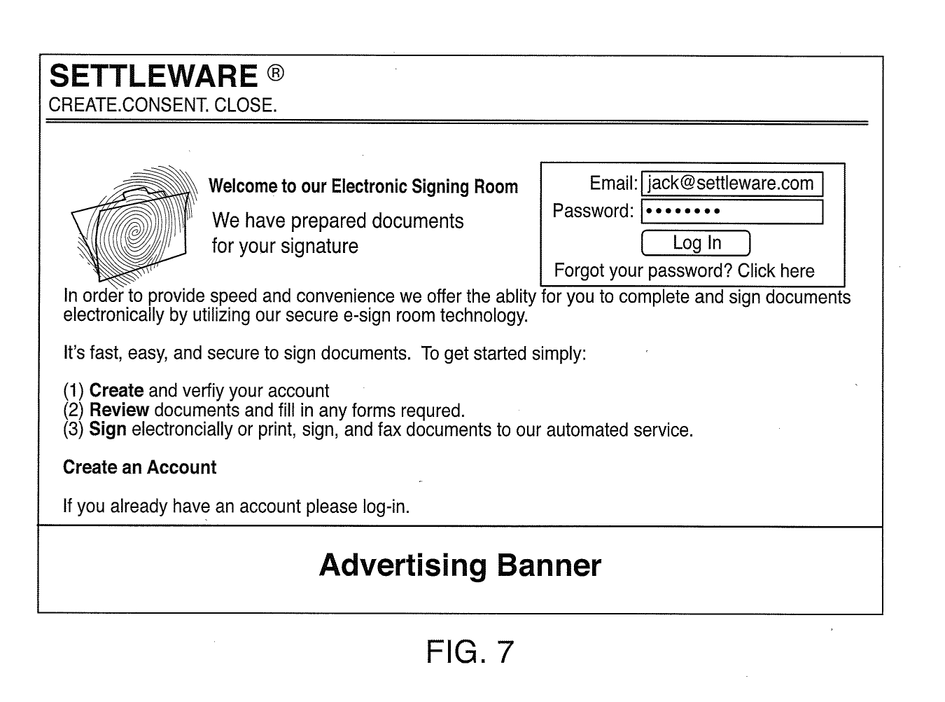

In step 514, the portal 10 searches the database of ads based on the user information (such as location information or based on the markets that a particular advertisement space the user is viewing represents) to find an ad that is particularly suited or tailored to the user or Submitter 12, and selects a specific ad or ads based on the Submitter's characteristic information or user information (e.g., location, profession, etc.). The portal 10 can profile users and assign them to particular markets by analyzing their IP addresses and web browser information. Certain markets can be given more weight than others in the decision of which ads to select or where to display them. In step 516, the portal 10 serves the selected ad(s) to the Submitter 12 in the portal or e-signing room. FIGS. 7 and 8 are example screen shots of ads being served to a user in the portal or e-signing room, after the user has been authenticated and gained access to the private network. It is of course to be understood that FIG. 7 is just an example, and that ads can be served to any user on any page and in any room.

In step 518 the Submitter 12 is prompted to upload the document(s) to be routed to the Recipient(s) 14 for electronic or e-signature. All document types can be accommodated, for example Word, Wordperfect, Excel, pdf, etc.

Parties (Submitters/Receivers/vendors) can upload document(s) via the portal 10 and/or mobile PDA, or any other suitable process (such as set top device, etc.). Parties can upload documents to their PDA (iPhone, Google apps, etc.) to submit to parties. Parties also have the ability to retrieve, copy, and scan original paper-based documents and upload them into the portal 10 on demand. For example, if a party has a paper document and needs to sign the document and get the document back to another party quickly, the party can use his PDA, take a picture of each page of the document, upload the document into the portal, Signing room, etc., and submit the document to the recipient for review and signature.

In step 520 the document(s) to be e-signed are received by the portal 10 from the Submitter 12.

In step 522 the portal 10 notifies the Recipient 14 accordingly and routes the document(s) to the Recipient(s) 14 which may include non-signing parties. This routing may be done such that the Recipient 14 can simply click on a hypertext link that takes the Recipient 14 to the document and to any relevant instructions (e.g., where to sign and initial, a greeting message, etc.). Alternatively, the portal 10 can prompt the Recipient 14 to download the document.

In step 524 the portal 10 receives the e-signed document from the Recipient(s) 14 after the Recipient(s) have authenticated identity, reviewed, and electronically signed the document(s). The Recipient 14 can be served ads from the database in a similar fashion as described above.

In step 526 the portal 10 transmits the e-signed document to the Submitter 12 for e-signature (if applicable). In step 528 the portal 10 receives the e-signed document from the Submitter 12 after the Submitter signs the document (if applicable). In step 530 the portal 10 merges all the signatures into one document (if applicable).

In step 532 the portal 10 confirms completion of all signatures and delivers copies of the originally signed document(s) to all parties to the transaction or appropriate non-parties, including non-signers.

In step 534 the transaction is closed.

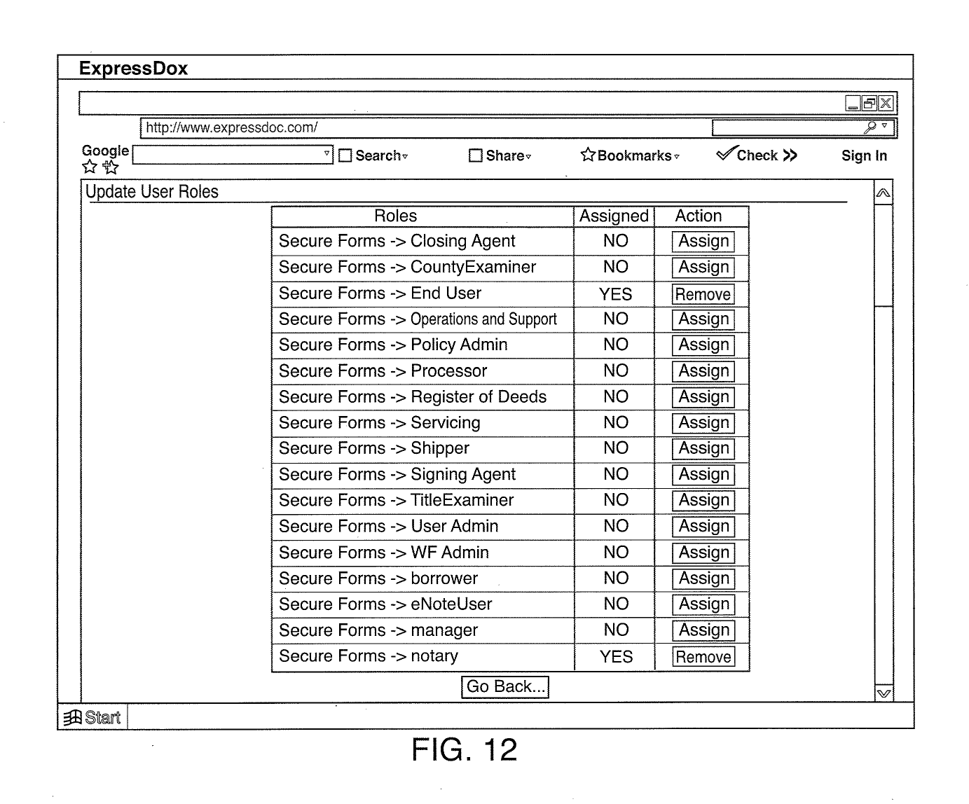

During the above-noted process all parties of the transaction can be provided ads at any point in the process, in any room of the portal, using the techniques described herein. FIG. 12 shows a list of parties which may potentially be served ads.

Ads can be delivered to parties' mobile devices, e.g., parties can save ads on their PDAs (iPhone, Google apps, etc.). A mobile application can be built on, e.g., an iPhone, or via Google or Verizon, etc. for storing ads for later use.

Further, the present invention in one aspect has the feature that when a recipient receives an advertisement, the recipient can click on the advertisement and automatically be sent a contract/agreement for e-signature.

Documents can be uploaded through social media and satellite communications, and the like.

In another example embodiment, a desktop web-based solution connects Attorneys with a Courthouse and enables the Attorneys to search for civil/criminal records. A database of ads to be served to the Attorneys in the portal is created or accessed. Once the Attorney activates with his or her user ID and password, he or she gains access to the portal. User information is obtained on the Attorney via the authentication information, etc. The database is searched based on the user information to find an ad or ads that are tailored to the Attorney.

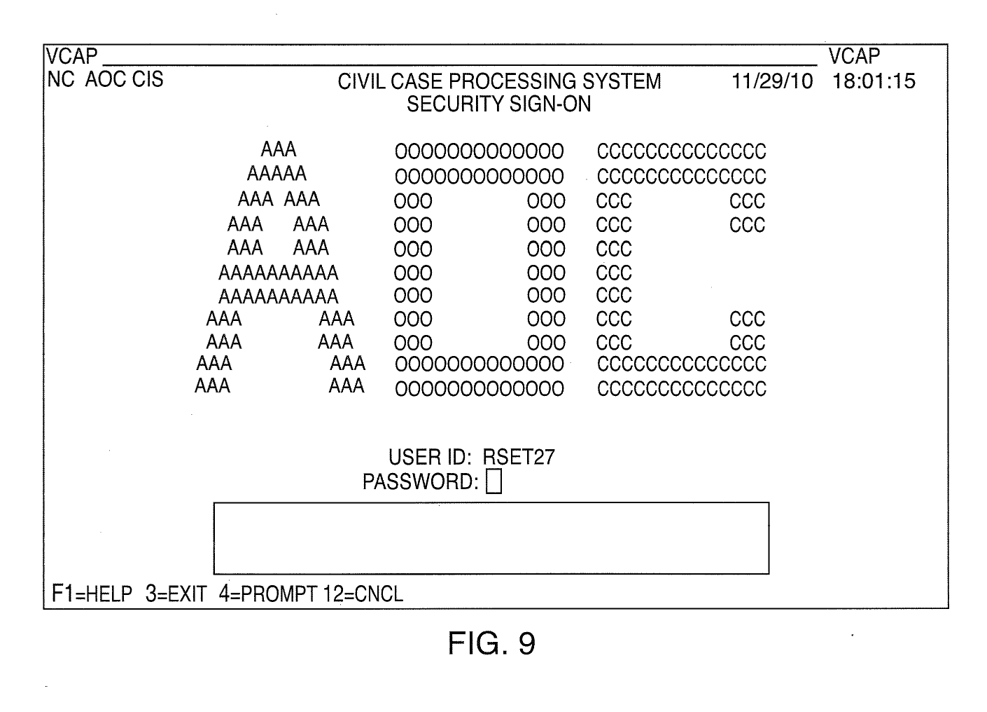

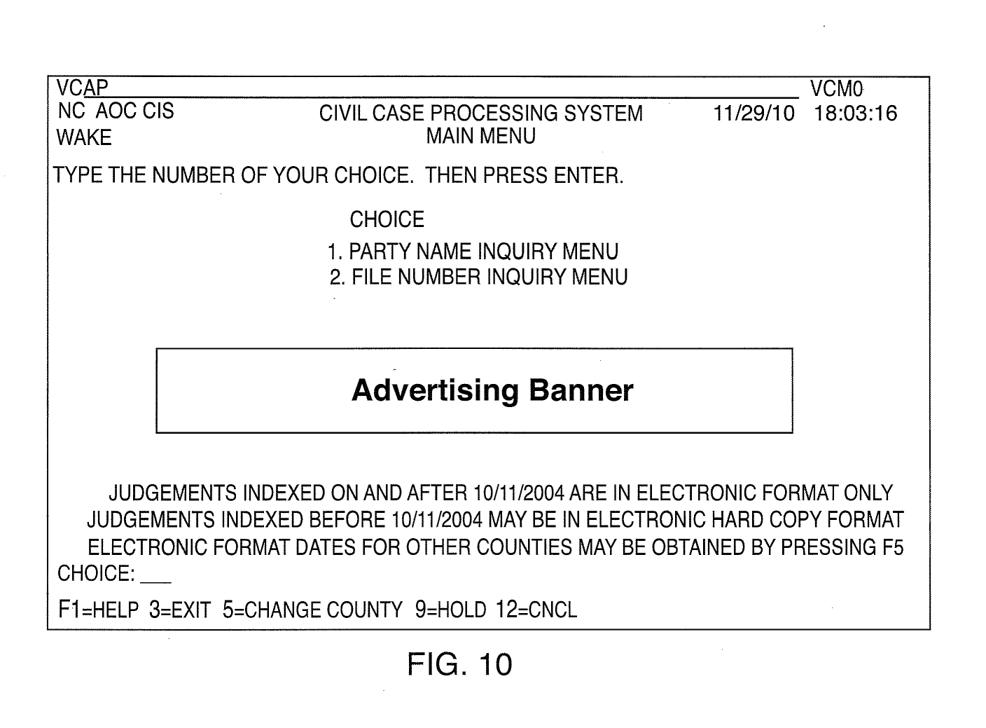

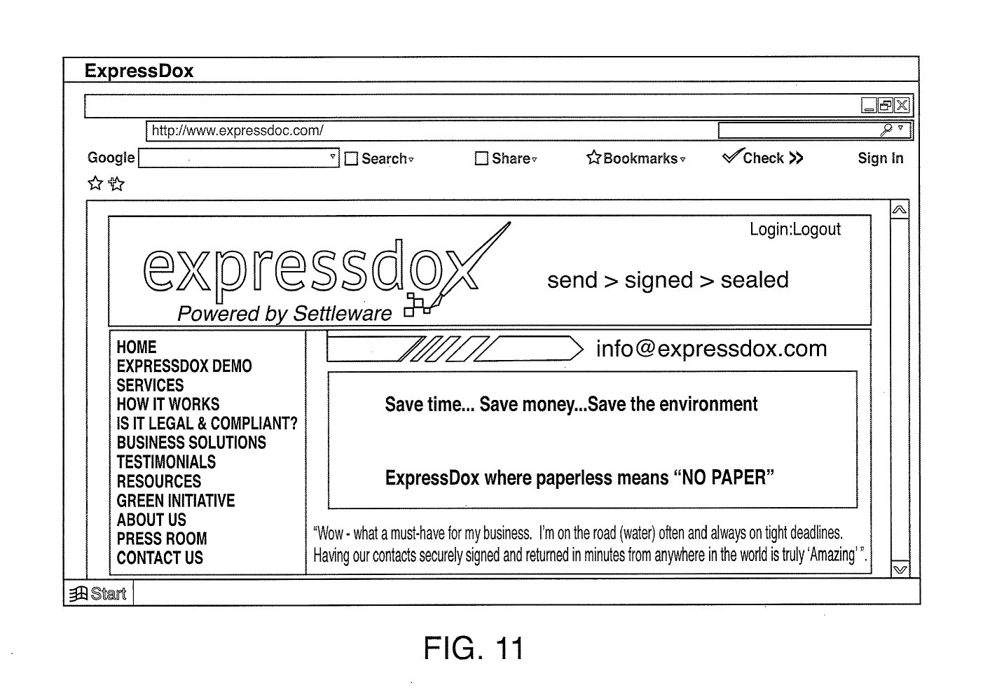

Advertisements/banners are added/served based on the results of the search once the Attorney logs in. FIGS. 9 and 10 are example screen shots of this embodiment, showing advertisements therein.

Accordingly, by virtue of the features of the present invention, an electronic signing portal can display advertising to a user based on the markets that a particular advertisement space the user is viewing represents and the markets that the user represents. Each advertising space in the system is identified as belonging to a number of markets; examples of markets for ads include “Chicago, Ill.,” “real estate hazard disclosure agreements,” and “ads above the fold on the front page of a signing portal”.

Sizes of markets vary, and some markets, such as “real estate hazard disclosure agreements,” are subsets of others, such as “real estate agreements.” Markets can also be defined by user demographics, such as “users over 50,” “homeowners,” etc. Along with directly soliciting demographic information on users, the system can profile users and assign them to particular markets by analyzing their IP addresses and web browser information. The present invention can enable ad buyers to choose which markets they wish to target, paying extra for highly competitive markets. Ads can be purchased in multiple markets with certain markets given more ‘weight’ than others in the decision of where to display ads. Also, when a person securely enters a vpn, he or she would be automatically identified. For example, in a system that allows viewing of court documents, clients or persons would have access to court records through a vpn. Once inside, these attorneys, paralegals, bail bondsmen, etc. can receive a highly target offer/advertisement, etc.

The present invention in one aspect, therefore, provides an advertising platform which operates taking into account the behavioral patterns or characteristic information shown by users that make them statistically more likely to purchase. In addition to showing users a brand message, offer, incentive, promotion, the present invention can also stream or show video or display ads that may more likely resonate with the user.

Moreover, the present invention in one aspect leverages sms texting and can identify users through social media or accounts and profiles from Facebook, Twitter, Pinterest, Google, Pay Pal, DropBox, Box, Instagram, Zillow, Membership-based organizations, other portals, and the like. Thus, parties can be identified without having to pre-register or register into the system. For example, if a deal exists with Real Estate Company A then it is already known that someone in that room is already a real estate agent without them having to register their profile with the system. As another example, if someone comes to the web portal, looks at a demo, goes to a shopping cart but does not purchase anything, the machine data can nevertheless be collected and some unique identification can be made, such as location. Through sms the needed info for advertising can be obtained based on information such as phone number, etc.

### GLOSSARY

The following terms and definitions are provided for the convenience of the reader; no limitation on the scope of the invention is intended by this GLOSSARY nor should any be implied therefrom.

“Client-Server”: A model of interaction in a distributed computer network system in which a program at one site sends a request to another site and then waits for a response. The requesting program is called the “client,” and the program which responds to the request is called the “server.” In the context of the World Wide Web (“www” or “web” defined hereinafter), the client is a “browser;” i.e., a program which runs on a computer of an end-user. A program and network computer which responds to a browser request by serving web pages and the like, is referred to as a “server.” Specialized servers, such as dedicated electronic mail (defined hereinafter) servers are also known in the art.

“Electronic Mail” (“e-mail”): The process and software for sending and receiving of textual information and attachments thereto between end-users over a distributed computer network such as the internet; internet access providers often include e-mail service to its customers as part of the access software that allows the end user to dial into the internet.

“Internet”: A generic term for a collection of distributed, interconnected networks (ARPANET, DARPANET, World Wide Web, or the like) that are linked together by a set of industry standard protocols (e.g., TCP/IP, HTTP, UDP (defined hereinafter), and the like) to form a global, distributed network.

“Hypertext Mark-up Language” (“HTML”): A standard coding convention and set of codes for attaching presentation and linking attributes to informational content within documents; the primary standard used for generating web documents. During a document authoring stage, the HTML codes (referred to as “tags”) are embedded within the informational content of the document; when the document is subsequently transferred from a server to a client, the codes are interpreted by the browser and used to parse and display the document. In specifying how the browser is to display the document, HTML tags can be used to create hyperlinks to other web documents.

“HyperText Transport Protocol” (“HTTP”): The standard Internet (infra) client-server protocol used for the exchange of information such as HTML documents and client requests for such documents between a browser and the server. HTTP—or HML or the like—includes a number of different types of messages which can be sent from the client to the server to request different types of server actions. For example, a “get” message which has the format GET<URL>(defined hereinafter) causes the server to return the document or file located at the specified URL.

“Internet”: A generic term for a collection of distributed, interconnected networks (ARPANET, DARPANET, World Wide Web, or the like) that are linked together by a set of industry standard protocols (e.g., TCP/IP, HTTP, UDP (defined hereinafter), and the like) to form a global, distributed network.

“Web Site”: A computer system that serves informational content over a network using standard protocols of the web. Typically, a web site corresponds to a particular internet domain name, such as WIDGET.COM″, and includes the content associated with a particular organization such as Widget Company. The term is generally intended to encompass both (1) the hardware/software server components that serve the informational content over the network, and (2) the “back-end” hardware-software components, including any non-standard or specialized components that interact with the server component to perform service for web site users.

“World Wide Web” (WWW or simply “web”): Refers generally to both (1) a distributed collection of interlinked, user-viewable hypertext documents (“web documents” or “web pages”) that are accessible via the internet, and (2) the client and server software components which provide user access to such documents using standardized internet protocols. Currently, the primary standard protocol for allowing applications to locate and acquire web documents is HTTP, and the web pages are encoded using HTML. However, the terms “web” and WWW or “world wide web” as used herein are intended to encompass future mark-up languages and transport protocols which may be used.

In the main, an escrow is a third party to a transaction between a seller and a buyer (the buyer and seller are collectively referred to as the “principals”). A deed, a bond, money, a piece of property, or other valuable, is delivered to the third party—hereinafter referred to as the “escrow officer”—to be delivered by the officer to the grantee only upon the fulfillment of all the conditions precedent which are imposed upon the principals and are usually of the express terms and conditions of a purchase and sale agreement (also referred to more simply as the “sales contract” hereinafter). In essence, the property is placed in trust in an escrow account.

Escrow transactions can be for both personal and real property. Some states (e.g. California) provide for the use of licensed escrow agents when a sale of real estate is being transacted. For the purpose of describing the present invention, an exemplary escrow transaction for real estate is considered; no limitation on the scope of the invention is intended by the inventor nor should any be implied therefrom.

While computers are important tools for the buyers and sellers of a valuable property jointly referred to as the “principals”), in the main, the use of actual purchase agreements, escrow services and associated contracts, such as loan agreements, are handled manually since the true identity of the principals and their agreement by signature on the assorted contracts and documents involved is a critical, personal factor. Notarization on the more important documents is often required. The coordination of the various entities involved with the transfer of a real estate property--namely the principals, agents, real estate brokers, attorneys, lending institutions such as banks or other mortgage related institutions, insurance companies, government and quasi-governmental entities (such as county clerk offices, local real estate boards, state deed recording and tax departments, and the like), vendors (e.g., title companies, property inspectors, property assessors, home owners associations, and the like), and any and all other entities involved in the transaction to be escrowed, is assigned to a licensed escrow agent. In turn, the escrow agent usually must involve the aid of administrative assistants to track all of the required paperwork and transfer of funds necessary to complete the transaction. As can be imagined, the number of such real estate transactions in a single California county on a daily basis is enormous. Moreover, commercial realty transactions involve even more complex service involving even more service providers.

Buyers are often “pre-qualified” by a lending institution for a particular loan amount even before seeking the right property. As a result, one of the problems of the marketplace is that the cause of delays experienced in valuable property exchange escrow transactions have shifted from the lending institution to the escrow agent. In some states, e.g., California, real estate transactions are regularly conducted via an escrow.

With the establishment of the internet, the world wide web, and the like, the emergence of e-commerce has generated a need for a computerized method and apparatus for processing escrow transactions and a method of managing escrows using such tools.

The system and method of operation of the present invention includes the use computerized devices and telecommunications devices connected to the Internet (or the like) which is adapted to perform: receiving instructions for the opening of an escrow; providing and sending digital instructions to all parties involved in the transaction; is offering the availability of a continuous digital escrow transaction by coordinating and permitting access to the on-going status of an escrow in progress; on-line digital signature, voice, video fingerprint or retina scanning personal identification authentication; transfer of funds or other consideration; submission of loan documents; closing escrow, delivering clear title, and release of transaction funds; and the like as would be useful in an escrow transaction.

The apparatus and method implements, manages, and tracks on-line digital transactions via an escrow, including opening, servicing, real-time or near-real time status of the broker, title company, lender, vendor, buyer and seller, and closing of an escrow via a medium such as the internet. Multiple access methods are employed. The present invention provides digital computerization and internet type process implementation for escrows including, but not limited to: escrow transaction coordination, escrow vendor service transaction coordination escrow status coordination and communication, seamless escrow transactions, party and third party personal identification authentication, such as on-line digital signature, thumb-print, retinal scan, video signature authentication, digital certificate authentication, and the like (generically referred to hereinafter as identification authentication; no limitation on the scope of the invention is intended by this list nor should any be implied), transmission of digital escrow instructions, and voice digital instructions, the merging of voice with escrow transactions, wireless escrow transactions, set-top/WebTV escrow transactions, global digital escrow networking, including appropriate data, application, and servers along with supporting LAN or WAN-based application to perform escrow services, and the like. In other words, the present invention proposes a completely computerized and networked system for any type of escrow transaction.

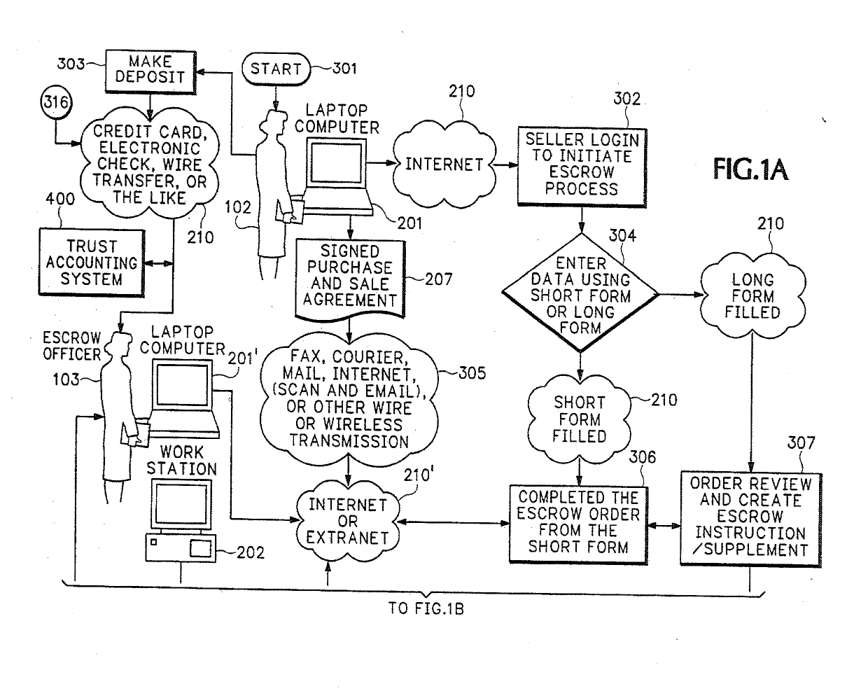

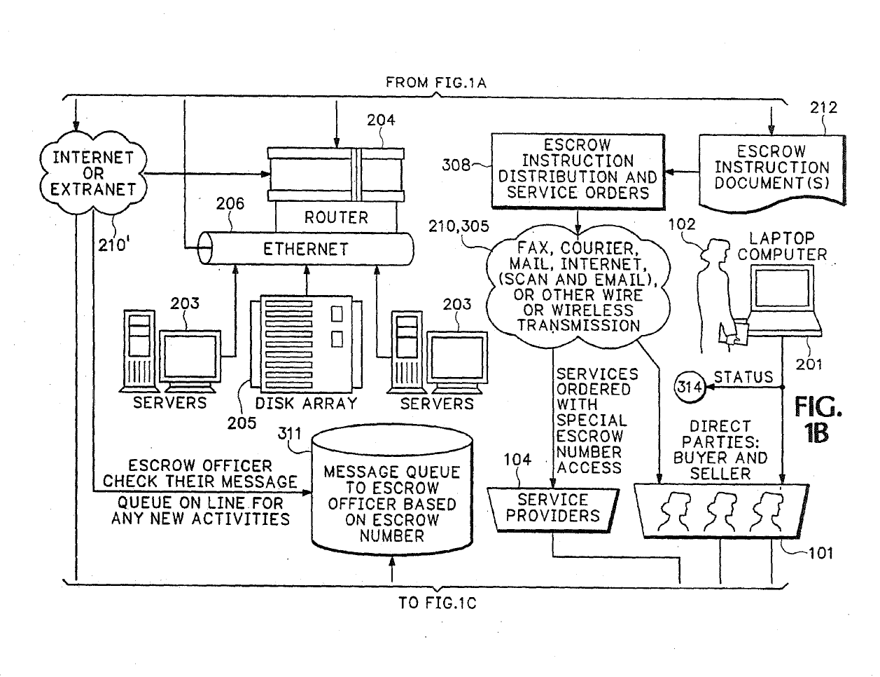

Turning to FIG. 1, standard, commercially available, computing and network serving apparatus employed in accordance with the present invention are schematically illustrated and labeled for identification: laptop computers 201—or personal digital assistants, wireless internet ready devices, or the like—workstation computers 202, (all such computer microprocessor-based type devices used by or useful to individuals in accordance with the present invention are collectively and generically referred to hereinafter as simply “computers;” no limitation on the scope of the invention is intended nor should any be implied), network routers 204, memory apparatus 205, networking equipment 206, and programs for operating; labeled cloud-balloons are used to depict the Internet or localized extranet 210′ services as known in the art. Provision can be made for foreign language use and interpretation. Digital handwriting recognition software can be employed.

The bulk of the equipment 202, 204, 205, 206 is located with an escrow officer 103 or escrow company employing the officer. In the main, a client-server relationship is provided between an escrow officer or company as the server and the other parties as the client. Note also that the functions related to the escrow company may be automated

As an example transaction to describe the present invention, a real estate purchase and sale and escrow transaction will be used. This example is only used to simplify the detailed description of the present invention; no limitation on the scope of the invention is intended nor should any be implied.

Let it be assumed that the principals 101 and their respective real estate agent(s) 102 have consummated an offer and acceptance for a specific piece of property—step 301, “START.” Further assume that the principals 101 and realty agent 102 have access to computers and associated printers, faxes, and the like, including appropriate Internet browser programs.

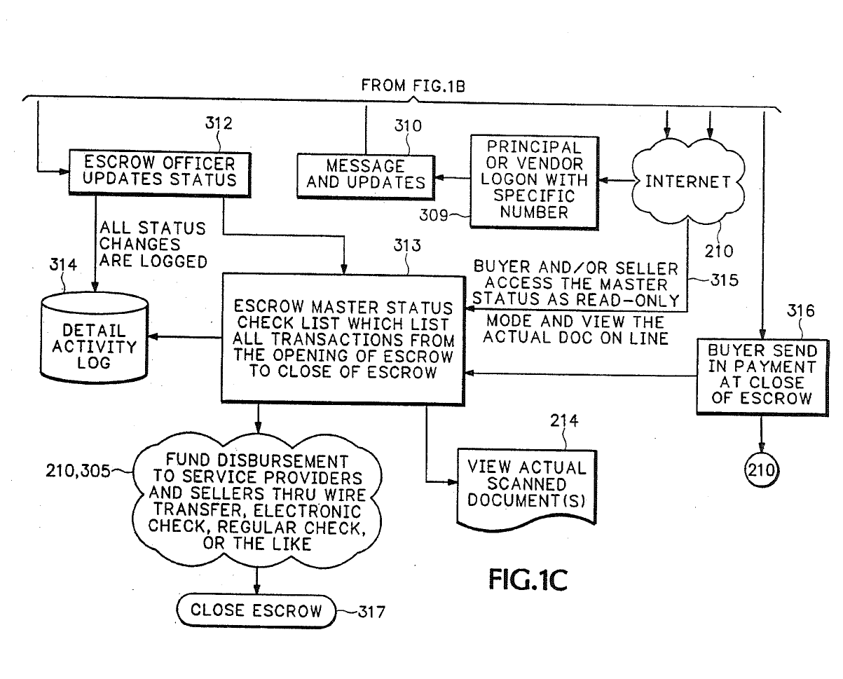

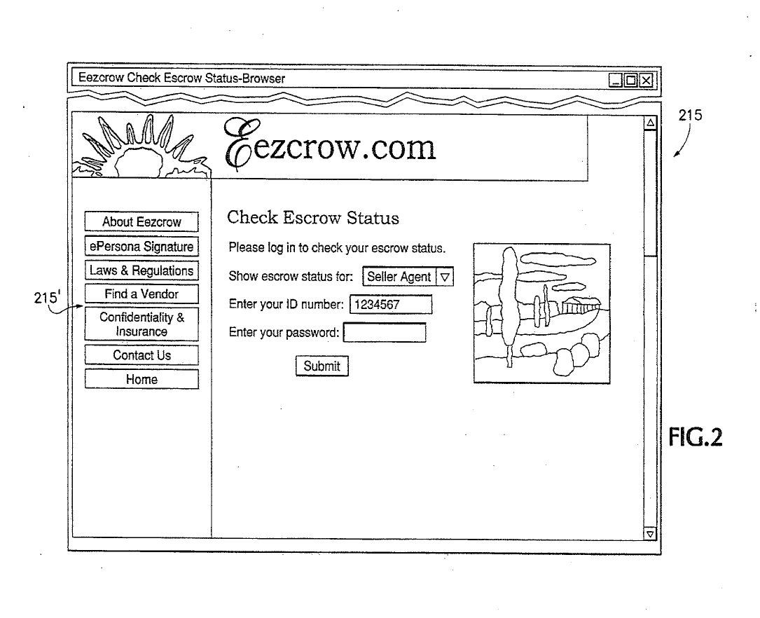

A purchase agreement 207 has been signed by the principals 101. It is therefore been agreed to open an escrow account to handle the complex details of the transaction with a particular escrow agent, or “officer,” 103. A principal's agent 102, having appropriate components of a program in accordance with the present invention--referred to hereinafter as EEZCROW™ program (EEZCROW is a trademark of EEZCROW Company of Laguna Beach, Calif.) loaded on a computer 201, using the internet 210, logs into the EEZCROW program—step 302, “Seller Login to Initiate Escrow Process”—connecting to the computer 201′ or 202 of the escrow officer 103 representing the licensed escrow company involved. FIG. 2 is an exemplary computer screen 215 associated with a Log-In procedure in accordance with the present invention. Note that virtual buttons Personal identification authentication is an important part of the escrow process. Using one or more state of the art digital identification authentication technologies, the principals 101 and agent 102 and officer 103 are each provided with unique identities so that the escrow process will be completely secure and confidential. Other involved entities may be added as needed, e.g., lending institutions that may wish to transfer funds electronically.

Two transactions take place. First, a deposit in accordance with the signed purchase agreement 207 is transferred via the internet 210 to the escrow officer 103—step 303, “Deposit.” A trust accounting system 400 is incorporated into the process. Fund data, such as credit card information, electronic checking, wire transfer, or the like, is procured from the seller 101. Second, the agent 102 provides the information that the escrow officer 103 will need to accomplish the various escrow tasks and obligations—referred to generically hereinafter as the “escrow order.” The agent 102 uses forms provided as part of the EEZCROW program module, or other compatible electronic forms, on their computer 201—step 304, “Enter data using Short Form or Long Form.” The form is then transmitted to the escrow officer via the Internet 210, the escrow officer having appropriate modules of the EEZCROW program on their computer(s) 201′, 202. Note that this initial document, in Short Form or Long Form, basically resides in memory accessible by the escrow officer 103, such as the disk array 205. This memory is accessible by the escrow officer 103 through either an Internet or Extranet connection 210′ from either a laptop 201′ or office workstation 202. It should be recognized by those skilled in the art that appropriate security modules are used in accordance with the present invention for verification of all parties described and yet to be described, digital signature approval, documents and funds access, and the like. Additionally, the realty agent 102 may use their computer to transmit a copy of the signed purchase agreement 207 to the escrow officer 103—step 305.

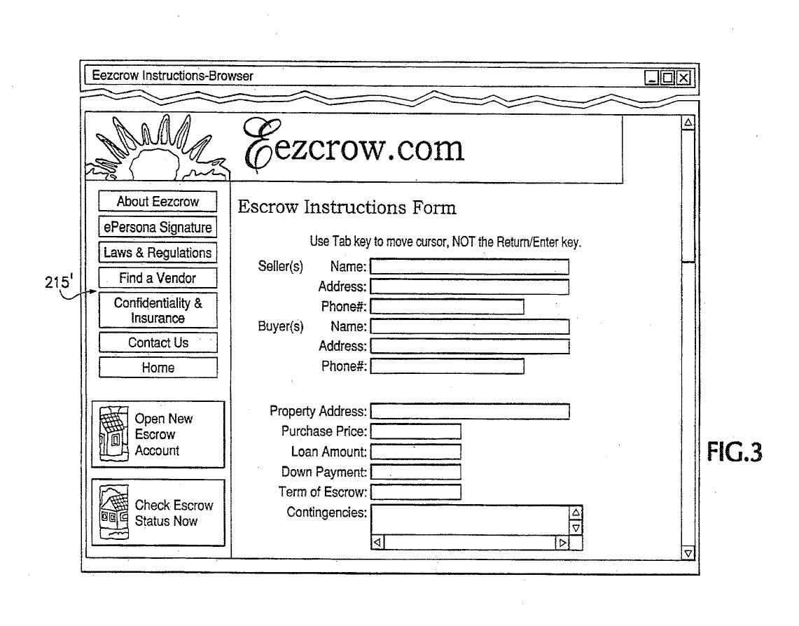

FIG. 3 is an exemplary, computerized Escrow Instructions Form as might appear on the computer 201 screen; see step 304. Again, having the appropriate modules of the EEZCROW program, the realty agent 102 provides the applicable data by filling in the blanks and the Form is transmitted back to the escrow officer 103. Moreover, any and all official documents associated with opening an escrow account is captured electronically (if not digitally available, scanned or the like) and transmitted with the Escrow Instructions Form.

It is now incumbent upon the escrow officer 103 to either complete the Escrow Instructions Form as an escrow order—step 306—or to review the order—step 307, and to create therefrom a specific, identifiable (e.g., by case number or other designator), and their escrow instructions document 212, spelling out the duties, rights, and obligations of the principals 101, the realty agent 101, and the escrow officer 103. The escrow officer 103—preferably via Internet, but if certain parties do not have access, via other distribution channels—then distributes the appropriate escrow instructions and orders any services that the escrow officer 103 is obligated to perform or have performed by service providers 104—step 308, “Escrow Instruction Distribution and Service Orders.” In this process step, the escrow instruction documents distributed electronically are distributed with case identification and specific log-in instructions, including party identification and security password, for on-line access and personal digital identification authentications and signatures.

Any EEZCROW modules that principals may need to participate via the Internet are transmitted with the escrow instructions to that particular principal or reside at the workstation 202 where the principal can access forms or the like remotely from there own terminal. Note that the case file is thus available for party access to status check or update specific information for which they have a specific security key to access. For example, a lending institution may have a security key to access that section of the case file concerning a mortgage application and grant or denial status.

Each of the parties—the principals 101, realty agent(s) 102, and service providers/vendors 104—has access to the escrow account file residing on the escrow officer 104 company computer memory 205 via the Internet 210. The escrow account file is analogous to a web site. At any time, these parties 101, 102, 104 can log—step 309 and, using the specific escrow account number and their security key, can provide updates or other messages to the escrow officer 103—step 310. The escrow officer 104 is kept apprised of all activity, preferably via electronic mail messages—step 311—stored in main memory 205 or an auxiliary memory (schematically represented by the barrel shaped icon in FIG. 1). Note that in order to ensure proper escrow processing, it may be provided that all updates 310 are actually funneled through the escrow office 103 for entering into the escrow account file—step 312.

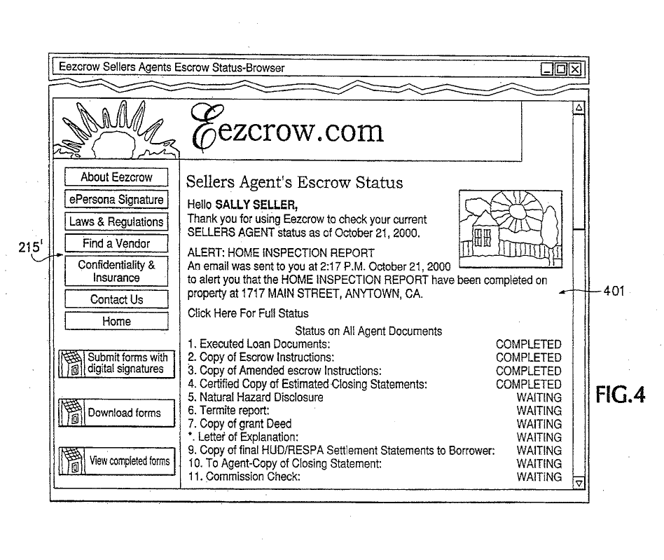

It is generally the escrow officer's 103 duty to maintain the escrow Master Status record—step 313. This includes the review and verification, or questioning of, important documents—e.g., grant deeds, certificates of ownership, title insurance policies loan documents and applications, homeowners association documents, zoning disclosure reports, home warranty policies, pest and other property inspection reports, natural hazard disclosures, geological reports, lead-based paint inspections, escrow settlement statements, government and quasi-government forms (e.g. CAL-FIRPTA, RESPA, Megan's Law, and the like), and the like documents 214—which are necessary, or advisable, to completing the escrow. The escrow officer 103 will keep a detailed escrow activity log as part of the escrow account file—step 314. Note that as the principals 101 have individual and somewhat conflicting agendas in completing the transaction, the principals access to the Master Status record 313 is preferably kept to a “read only” mode, path 315. In other words, while a buyer or seller might provide update information 310 to the escrow officer 103 for appropriate action or inaction, they have no security key to access the actual Master Status record 313. FIG. 4 is an exemplary computer screen display 401 demonstrating an escrow account status in accordance with the present invention.

Once all conditions of the escrow have been met, the buyer sends in the necessary funds to close escrow—step 316. The escrow officer 102 then completes all the necessary requirements—such as recording deeds, transfer of title (including title insurance), distribution of payments, and the like—necessary or important documents to close the escrow—step 317.

The present invention or any part(s) or function(s) thereof, may be implemented using hardware, software, or a combination thereof, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

The foregoing description of the preferred embodiments of the present invention has been presented for purposes of illustration and description. It is not intended to be exhaustive or to limit the invention to the precise form or to exemplary embodiments disclosed. Obviously, many modifications and variations will be apparent to practitioners skilled in this art. Similarly, any process steps described might be interchangeable with other steps in order to achieve the same result. The embodiment was chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . . ”

It should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. A system for selecting and displaying targeted advertisements in a web portal enabling electronic processing or viewing of documents, comprising:
a server coupled to a network including a memory and a processor configured to:
via online communications provide an e-signing room in the web portal that enables at least one of viewing, uploading, and downloading of documents, and electronic or digital signing of said documents;
provide access to the e-signing room to at least one party based on a registration or receiving or authentication process;
determine at least one characteristic relating to the at least one party from the registration or receiving or authentication process;
access a memory of advertisements having key words relating to each advertisement;
search the memory for at least one advertisement that is particularly suited to the at least one party based on a comparison of at least one characteristic to the key words relating to the advertisement;
select at least one advertisement from the memory based on the search; and
serve the at least one advertisement selected from the memory to the e-signing room.

2. The system of claim 1, wherein the at least one party is from a group comprising an individual, a principal, a broker, an agent, a service provider, a vendor, an affiliate, an attorney, an escrow settlement officer, a title company, a Submitter, a Recipient, or a third party.

3. The system of claim 1, wherein the characteristics relating to the at least one party include at least one of profession, title, buyer, seller, borrower, agent, occupation, hobby, interest, profile, street, city, state, zip code, area code, location of job, location of home, age, sex, and an application or a tool used in the course of work.

4. The system of claim 1, wherein the advertisements include at least one of a promotion, a coupon, discount, introduction, referral, and a special offer.

5. The system of claim 1, wherein the server is further configured to import the advertisements into the database.

6. The system of claim 1, wherein the server is further configured to check whether the at least one party is a registered party, and, if so, to authenticate the party, and, if not, to initiate a registration process to register the party.

7. The system of claim 1, wherein the web portal is provided in connection with a transaction or escrow process for real or personal property.

8. The system of claim 1, wherein the web portal is provided in connection with a register of civil or criminal records.

9. A method for selecting and displaying targeted advertisements in a web portal enabling electronic processing of documents, comprising:
at a first computer coupled to an online network, providing an e-signing room or virtual private network in the web portal that enables at least one of viewing, uploading, and downloading of documents or information, and electronic or digital signing of said documents;
providing access to the e-signing room or virtual private network to at least one party based on a registration, login, receiving, or authentication process;
determine characteristic relating to the at least one party from the registration, login, receiving, or authentication process;
accessing a memory of advertisements having key words relating to each advertisement;
searching the memory for at least one advertisement that is particularly suited to the at least one party based on a comparison of at least one characteristic to the key words relating to the advertisement;
selecting at least one advertisement from the database based on the search; and
serving the at least one advertisement selected from the database to the e-signing room or virtual private network.

10. A computer program product, stored on a non-transitory computer readable medium, comprising instructions that, when executed on one or more computers, cause the one or more computers to perform operations to select and display targeted advertisements in a web portal enabling electronic processing of documents or access through a virtual private network, the operations comprising:
via online communications providing an e-signing room in the web portal that enables at least one of viewing, uploading, searching, and downloading of documents, and electronic or digital signing of said documents;
providing access to the e-signing room to at least one party based on a receiving, registration, or authentication process;
determining at least one characteristic relating to the at least one party from the receiving, registration, or authentication process;
accessing a memory of advertisements having key words relating to each advertisement;
searching the memory for at least one advertisement that is particularly suited to the at least one party based on a comparison of at least one characteristic to the key words relating to the advertisement;
selecting at least one advertisement from the memory based on the search; and
serving the at least one advertisement selected from the memory to the e-signing room.

11. A system for selecting and displaying targeted advertisements in a web portal enabling electronic processing or viewing of documents, comprising:
a server coupled to a network including a memory and a processor configured to:
via online communications provide a virtual room in the web portal that enables at least one of viewing, uploading, and downloading of documents;
provide access to the virtual room to at least one party based on a registration or receiving or authentication process;
determine at least one characteristic relating to the at least one party from the registration or receiving or authentication process;
access a memory of advertisements having key words relating to each advertisement;
search the memory for at least one advertisement that is particularly suited to the at least one party based on a comparison of at least one characteristic to the key words relating to the advertisement;
select at least one advertisement from the memory based on the search; and
serve the at least one advertisement selected from the memory to the virtual room.
